(19) United States
(12) Patent Application Publication
(10) Pub. No.: US 2009/0319152 A1
(43) Pub. Date: Dec. 24, 2009

(54) METHOD AND DEVICE FOR CONTROLLING AN INTERNAL COMBUSTION ENGINE

(76) Inventors: Peter Skala, Tamm (DE); Herbert Schumacher, Gerlingen (DE); Christos Hondros, Ludwigshurg (DE); Michael Scheidt, Suttgart (DE)

Correspondence Address: MICHAEL J. STRIKER, 103 EAST NECK ROAD, HUNTINGTON, NY, 11743, US

(21) Appl. No.: 12/520,696

(22) PCT Filed: Feb. 27, 2008
(86) PCT No.: PCT/EP2008/052349

§ 371 Date: Jun. 22, 2009

(30) Foreign Application Priority Data
Apr. 26, 2007 (DE) 10 2007 019 641.7

(51) Int. Cl. G06F 19/00

(52) U.S. Cl. 701/101

(57) ABSTRACT

The invention relates to a method and a device for controlling an internal combustion engine for which, in the light of performance characteristics, control parameters for at least one control element (100) are specified. A parameter is determined which characterizes the uneven running. In the light of the parameter, which characterizes the uneven running, a conclusion is drawn concerning the fuel properties

### BACKGROUND INFORMATION

The present invention is directed to a method and a device for controlling an internal combustion engine. A device of this type, and a method of this type are known, e.g. from DE 33 36 028. That publication describes a method for controlling an internal combustion engine, in the case of which controlled variables for at least one actuator are specified based on characteristic operating parameters. A regulator is assigned to a cylinder of the internal combustion engine, which adjusts the torque output by the cylinder to a common setpoint value. For this purpose, the engine speed signals in particular are adjusted to a common setpoint value. A procedure of this type is typically referred to as smooth running control. In this procedure, a correction value is defined for the quantity of fuel to be injected into the individual cylinder, based on a deviation of the single cylinder from a common mean.

Fuels of different qualities are often used to operate diesel internal combustion engines. As a result, e.g. the internal combustion engine outputs more or less power, and exhaust emissions are increased. Increased exhaust emissions occur in particular when low-quality fuel is used.

Using the procedure according to the present invention, it is possible to detect different fuel qualities and react to them appropriately. According to the present invention, it is provided that a conclusion concerning the fuel properties is drawn based on a variable that characterizes the uneven running. A variable that characterizes the uneven running is considered, in particular, to be a variable that is caused by stochastic torque fluctuations. According to the present invention, it was recognized that low fuel qualities cause stochastic torque fluctuations of this type.

The fact that the engine runs less smoothly is detected, and appropriate countermeasures are implemented. According to the present invention, it is provided that at least one controlled variable is corrected when a low fuel quality is detected via the fact that the variable that characterizes the uneven running exceeds a threshold value.

The measure that is implemented in particular is that the instant at which injection occurs is changed, the quantity of air that is supplied to the internal combustion engine is changed, the fuel pressure is changed, and/or, in the case of a diesel internal combustion engine, a glow process is initiated. These measures are implemented individually or in combination. In particular, the start of injection is advanced, the air quantity is corrected toward a higher air quantity, and the rail pressure is adjusted toward higher rail pressures.

It is particularly advantageous when these corrective actions are at least partially retracted when certain states exist, i.e. the correction value is set to zero, or the magnitude of the correction value is reduced to a smaller value. These certain operating states exist in particular when, e.g. it is detected that fuel was added to the tank. It may also be provided that this retraction of the correction values is carried out at certain intervals, in particular at certain time intervals or after a certain vehicle performance has taken place.

Stochastic fluctuations are detected by the fact that the engine speed increase which is caused by combustion in one of the cylinders, and/or the difference of consecutive minima and maxima in the instantaneous engine speed are/is evaluated. The difference and/or the engine speed are/is normalized for evaluation purposes.

The stochastic fluctuations are characterized by the fact that they do not occur regularly. In consecutive combustion cycles, they typically occur only once in any one cylinder.

### BRIEF DESCRIPTION OF THE DRAWING

Embodiments of the present invention are presented in the drawings and are described in greater detail in the description that follows.

FIG. 1 shows a block diagram of a device according to the present invention.

FIGS. 2 and 3 each show a flow chart that illustrates the procedure according to the present invention.

### EMBODIMENTS OF THE INVENTION

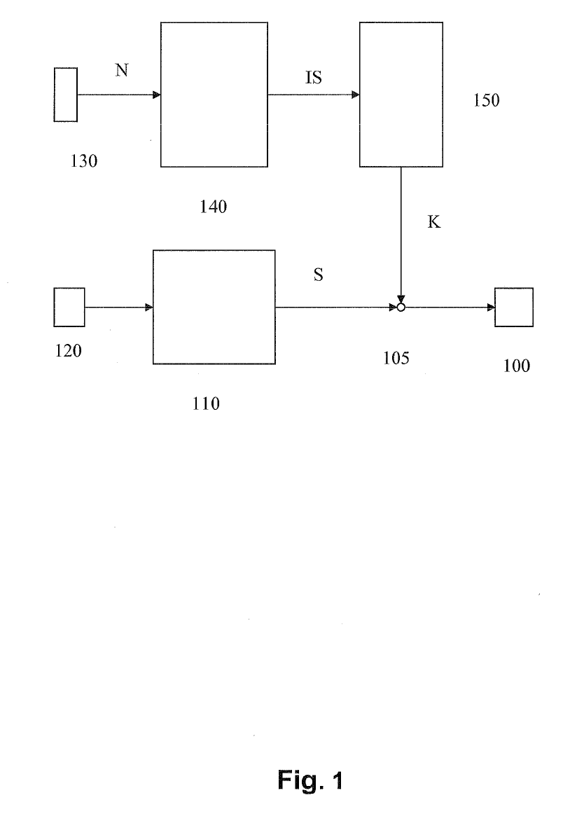

FIG. 1 shows a block diagram that is a simplified depiction of a control system of an internal combustion engine. The elements described below are components of an engine control unit. An engine control unit of this type processes various signals and controls various actuators in the region of the internal combustion engine.

An actuator 100 is acted upon by an actuation signal S from a control system 110 via a linking point 105. Control system 110 processes various input signals from various sensors 120 and various variables that are present in an engine control unit. Based on these variables, control system 110 specifies triggering signal S, which is then applied to actuator 100.

This control system may be a simple open-loop control, in the case of which the triggering signal is specified based on the input variables. It may also be a closed-loop control, e.g. an RPM control, in the case of which a manipulated variable S is specified based on the comparison of an actual value and a setpoint value.

Control systems of this type are provided for various manipulated variables in the region of an internal combustion engine. A control system of this type is used, e.g. to control the point of injection, the rail pressure, the quantity of air delivered to the internal combustion engine, and/or a glow process of a glow plug.

The control system for the point of injection establishes the instant at which injection begins. This variable has a significant effect on the combustion behavior of the fuel in the case of a diesel internal combustion engine. The quantity of air that is delivered to the internal combustion engine is specified as a function of various variables, and it may be adjusted using various actuators. An exhaust gas recirculation valve, for example, is provided as an actuator of this type. The rail pressure which corresponds to the fuel pressure when the fuel is metered also has a strong effect on combustion. In addition to these variables, further variables may also be controlled in a similar manner.

A second sensor 130 delivers a signal N which represents the random torque fluctuations. A signal of this type is provided, e.g. by a speed sensor. This signal reaches an uneven running detection unit 140 which is designed in a manner such that it detects stochastic torque fluctuations and outputs an appropriate signal IS to a correction value determination unit 150. If stochastic torque fluctuations of this type are detected, correction value determination unit 150 outputs an appropriate correction signal K to a linking point 105. In linking point 105, signal K and signal S from control system 110 are linked, preferably in an additive manner, and are then used to trigger actuator 100.

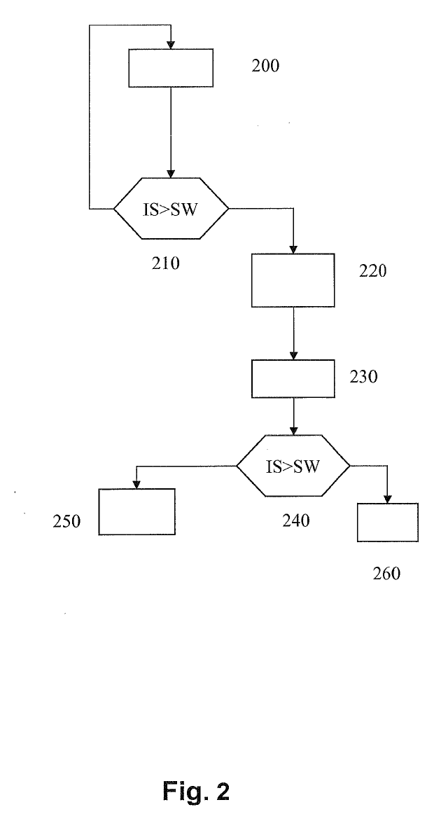

A procedure of this type is depicted in FIG. 2 in the form of a flow chart.

In a first step 200, a signal the represents a stochastic torque fluctuation is evaluated. In particular, the signal from a speed sensor is used for this purpose. Incremental wheels with a resolution of 6° of crankshaft rotation are typically used in a motor vehicle. A total of 60 minus 2 teeth are located on the circumference of an incremental wheel. The evaluation unit evaluates the sequence of these teeth, thereby yielding a speed signal with an angular resolution of 6° of crankshaft rotation. By carrying out a suitable evaluation, e.g. of a segment-synchronous speed detection, stochastic torque fluctuations are detected based on this signal.

Inquiry 210 checks to determine whether intensity IS of these stochastic torque fluctuations is greater than a threshold value SW. If it is not, step 200 is repeated. If it is, then, in step 220, a lower fuel quality is detected, and appropriate countermeasures are initiated. In this embodiment, variable IS may also be referred to as the characteristic fuel quality number.

As a countermeasure, it is provided, e.g. that a correction value K is specified, using which appropriate manipulated variables are corrected. After the correction is successfully implemented, the speed signal is evaluated once more, in step 230, in order to detect stochastic torque fluctuations. Inquiry 240 checks to determine whether intensity IS of these stochastic torque fluctuations is greater than a threshold value SW. If it is, the correction is retained in step 250. If it is not, a detection carried out in step 260 determines that the stochastic torque fluctuations are based on another cause, and not on lower fuel quality.

According to the present invention, it is therefore provided that the stochastic torque fluctuations are detected, and, if they exceed a certain level, a correction value K is specified in order to correct a suitable manipulated variable. If this correction of the manipulated variable results in a reduction of the stochastic fluctuations, the correction values are retained, and the manipulated variable is afterward corrected using related correction value K.

The check to determine whether torque fluctuations exist is preferably carried out during idle, since torque fluctuations are detected particularly reliably and easily during idle. The correction of the manipulated variables using correction value K is active in all operating states.

It is particularly advantageous that correction value K or other variables, based on which the correction value is ascertained, is/are stored in a memory that does not lose its contents when the control unit or the internal combustion engine is switched off. Preferably, an EEPROM is used for this purpose. Intensity IS of the stochastic fluctuations or the characteristic fuel quality number are stored in particular as the variable based on which the correction value is ascertained. When the internal combustion engine is restarted, these variables are available immediately for use to control the internal combustion engine.

If this measure is not successful, further measures that are not the subject matter of the present invention must be carried out. A successful outcome is detected, e.g. when, after a manipulated variable is corrected, intensity IS of the stochastic fluctuations becomes less pronounced than it was before the correction.

In this simplified embodiment, only one manipulated variable is corrected when the stochastic fluctuations exceed a certain intensity.

In an improved embodiment it is provided that correction value K is specified as a function of threshold value SW, and/or, also as a function of threshold value SW, a determination is made as to which subset of the manipulated variables noted is corrected. In this case, several threshold values are provided, and different reactions occur when the particular threshold values are exceeded. It may also be provided that a determination is made as a function of intensity IS of the fluctuations as to which value the correction value assumes, and which manipulated variables are corrected.

If the case now occurs in which a higher-quality fuel is added in a subsequent fill-up, it is no longer necessary, and is even counterproductive to perform a correction. It is therefore provided according to the present invention that a check is carried out at certain time intervals to determine whether this correction is necessary. To this end, a check is carried out in a first step 300 to determine whether a certain condition exists. A check may be carried out, for example, to determine whether a certain time condition exists. This means that the check is carried out at certain time intervals. As an alternative, it may also be provided that the check is carried out after a certain vehicle performance and/or a certain number of engine revolutions has taken place. It may also be provided that the check is carried out every time the internal combustion engine is started up, and/or every time fuel is added to the tank. It is particularly advantageous when there is a certain waiting period after fuel is added to the tank.

If it is detected in inquiry 300 that one of these conditions exists, an evaluation is carried out in step 310 to determine whether stochastic torque fluctuations exist. If it is detected in inquiry 320 that intensity IS of the fluctuations is greater than a threshold value, a detection is made in step 330 that low-quality fuel is still being used. However, if it is detected in inquiry 320 that the intensity of the fluctuations is lower than threshold value SW, a detection is made in step 340 that the fuel quality has changed. The correction values are therefore retracted in step 340.

That is, depending on the embodiment, the correction values are set to zero, or they are reduced by a certain amount or by a certain factor. Finally, in step 350, another evaluation is carried out to determine whether fluctuations occur. If it is detected in inquiry 360 that intensity IS of the fluctuations is lower than threshold value SW, a detection is made in step 370 that the fuel quality is good again. If it is detected in inquiry 360 that intensity IS of the fluctuations is greater than the threshold value, a new correction is carried out in step 380, and it is determined that the fuel quality is still low.

This means that a check is carried out at certain intervals to determine whether retracting the corrections causes the stochastic fluctuations to return. If this is the case, i.e. if the fluctuations return when the correction is retracted, then it may be assumed that the fuel quality has not improved. In this case, correction of the appropriate manipulated variable is continued. If retracting the correction value does not cause fluctuations to occur, then it may be assumed that the fuel quality improved when fuel was added to the tank. In this case, it may be assumed that the fuel quality has returned to its normal quality.

Depending on the embodiment, it may be provided that the correction value is retracted in one step, i.e. correction value K is set to zero. In one embodiment, it may also be provided that the retraction takes place in several steps or by using a different functionality.

The check to determine whether the fuel quality has improved is preferably carried out at certain time intervals or after a certain operating period of the internal combustion engine has passed, and/or after the vehicle has traveled a certain distance. Moreover, it may be provided that the check is carried out every time that fuel is added to the tank, in which case a certain time condition preferably must be met after fuel is added to the tank.

According to the present invention, the check to determine whether the fuel quality has improved is carried out when at least one of the conditions described above has been met. In an advantageous embodiment it is provided that all or several conditions are checked, and, if a condition exists, the procedure described above is carried out. In a simplified embodiment, only one of the conditions is met.

Moreover, this check to determine whether fluctuations reappear after the corrections are retracted is preferably carried out only during idle after the conditions, e.g. fuel was added to the tank or an interval has passed since the last check was carried out, have been met.

It is particularly advantageous for the fuel quality that is ascertained to be stored for a long duration in the engine control unit, so that it is available the next time the engine is started.

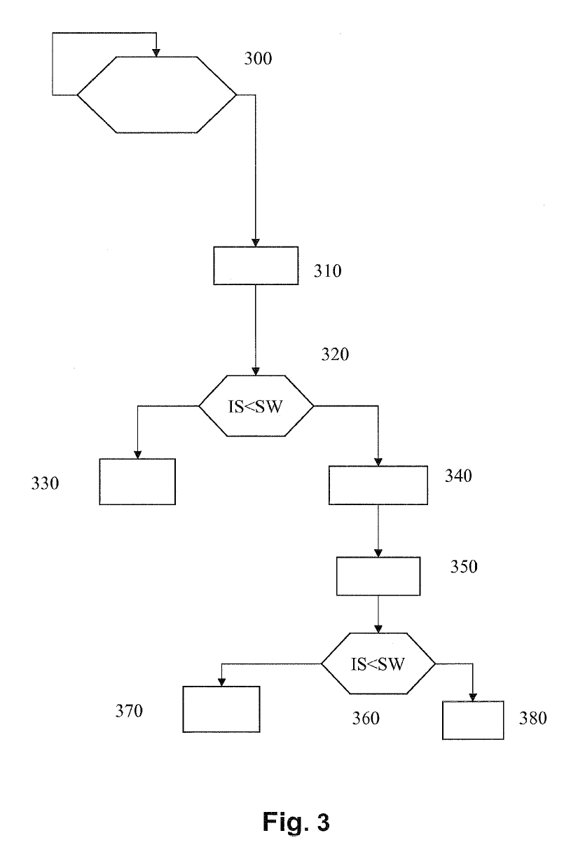

The detection of stochastic fluctuations is described below. According to the present invention, misfires are detected using misfire detection. The number of misfires that are detected is used as intensity IS of the stochastic fluctuations. As an alternative, a characteristic fuel quality number may be ascertained using the procedure described below. The characteristic fuel quality number may be processed instead of intensity IS of the fluctuations, as described with reference to FIGS. 2 and 3. Intensity IS of the fluctuation may also be referred to as the characteristic fuel quality number.

If misfires are detected, increases in engine speed resulting from combustion are ascertained in the range near idle, and they are evaluated. A moving average of the increases in engine speed dn over the previous cycle is calculated, and the result is subtracted from current value dnk.

$$d {\overline{n}}_{k} = \frac{1}{Zyl} {\sum }_{k = 0}^{Zyl - 1} {dn}_{k}$$

(mean increase over one cycle) (Zyl=cylinder)

x*^{d n̅}^{ₖ}

If dnk falls below an applicable threshold x*^{d n̅}^{ₖ}, a misfire is detected (0<x<1).

Stochastic misfires are detected using the embodiment described below. A comparison with mean increase d n̅ₖ is not carried out; instead, the mean increase is subtracted from the current value, and is multiplied by the mean engine speed divided by a scaling factor.

$${dn}_{misf , k} = ( {dn}_{k} - d \overline{n} , k ) ⋆ \frac{n}{Normierung} . \\ ( Normierung = scaling factor )$$

Negative values indicate delays. If a specified negative threshold value is fallen below, then a misfire exists. This change makes it possible to detect misfires across the entire range of engine speed, and to match them to particular cylinders.

In a further embodiment, the cubic sum is calculated across one cycle. This is carried out using the following formula:

$${y}_{k} = \sum {dn}_{misf , k}^{3}$$

Using this measure, noise is suppressed and strong fluctuations caused by misfires are emphasized.

Furthermore, statistics on fluctuations in engine speed and torque may be calculated for individual cylinders by accounting for the value of the most recent cycle of the particular cylinder. The difference between the current value and that of the most recent cycle is calculated.

dn*ₖ=dn_{misf,k}−dn_{misf,k-Zyl}

(Zyl=cylinder)

Using conventional statistical methods, it is possible to calculate the fluctuation of cylinder-individual values k=0 . . . Zyl−1 (moving standard deviation or calculation of the absolute value, and PT1 filtering).

If similar statistics are calculated not for an individual dn*ₖ, but across all dn*ₖ, the result is a numerical value SI for stochastic torque fluctuations of the entire engine.

DE 10 2006 018 958 makes known a misfire detection process in which the differences between consecutive minima and maxima are determined instead of increases in engine speed. The following formula is used to calculate the difference between consecutive minima and maxima:

dnₖ=(nₖ−nₖ₋₂)

To suppress dynamic problems via moderate acceleration, a mean difference d̅n̅ₖ̅ across the previous cycle is calculated, and it is subtracted from current value dnk. Misfires are detected when the value which has been calculated in this manner falls below a certain negative threshold.

In one embodiment, the difference between the minima and maxima is normalized using the following formula:

$$\begin{matrix}{dn}_{k} = ( {n}_{k} - {n}_{k - 2} ) \frac{n}{Normierung} & ( Normierung = scaling factor ) \\ \overline{{dn}_{k}} = \frac{1}{2 ⋆ Zyl} {\sum }_{k = 0}^{2 ⋆ Zyl - 1} {dn}_{k} & ( Zyl = cylinder ) \\ {dn}_{k}^{*} = {dn}_{k} - \overline{{dn}_{k}} & \end{matrix}$$

Assignment to a cylinder is carried out using the method described in DE 102006018958, or via displacement and downsampling. Misfires are detected when a threshold is fallen below.

Displacement by a certain number of segments s with t number of places to the right of the decimal:

dnsegₖ=(1−t)*dn*ₖ₋ₛ+t*dn*ₖ₋ₛ₋ᵢ

### Downsampling:

Every 2nd value of ^{dnseg} k for even k is stored in a matrix dak (m, n) for a certain number of previous cycles m, and for the number of cylinders n (k=0 . . . 2 Zyl−1).

Based on matrix dak, the statistical analyses mentioned above are carried out individually for cylinders and for the entire engine. In an advantageous development, it is provided that a correction of tooth spacing errors is carried out in advance, and/or that a low-pass filtering of the engine speed signal is carried out in order to prevent aliasing effects. This increases the signal quality and, therefore, the quality of the statistics.

Furthermore, stochastic fluctuations may be detected based on regulations that carry out cylinder torque equalization. The presence of stochastic torque fluctuations is detected by the fact that it is not possible to regulate the control deviation to 0, but rather that permanent fluctuations in the control deviation exist for individual cylinders.

A statistical analysis of control deviations of all cylinders is a measure of stochastic torque fluctuations. Stochastic misfires may not be assigned to specific cylinders in this case, but for large fluctuation values in the statistics.

According to the present invention, it is possible to perform statistical analyses in cases in which features are formed that are proportional to torque.

What is claimed is:

1. A method for controlling an internal combustion engine, in which, based on characteristic operating parameters, controlled variables for at least one actuator (100) are specified, and a variable is ascertained that characterizes uneven running,
wherein,
based on the variable that characterizes the uneven running, a conclusion is drawn concerning the fuel properties.

2. The method as recited in claim 1, in which, based on the variable that characterizes the uneven running, a characteristic fuel quality number is ascertained.

3. The method as recited in claim 1, in which a poor fuel quality is detected when the variable that characterizes the uneven running exceeds a threshold value.

4. The method as recited in claim 1,
wherein
the variable that characterizes the uneven running characterizes the stochastic uneven running.

5. The method as recited in claim 1,
wherein
at least one controlled variable is corrected when a low fuel quality is detected.

6. The method as recited in claim 1,
wherein
the variable that characterizes the uneven running, the characteristic fuel quality number, or further variables are stored permanently.

7. The method as recited in claim 1,
wherein
the correction is retracted at least partially when certain conditions exist.

8. The method as recited in claim 7,
wherein
the certain states exist when the internal combustion engine is started, and/or when it was detected that fuel was added to the tank.

9. The method as recited in claim 7,
wherein
the correction is retracted at least partially, at certain intervals.

10. A device for controlling an internal combustion engine, which, based on characteristic operating parameters, specifies controlled variables for at least one actuator, and ascertains a variable that characterizes uneven running,
wherein
means are provided for drawing a conclusion regarding the fuel properties based on the variable that characterizes uneven running.
